(19) United States
(12) Patent Application Publication
(10) Pub. No.: US 2003/0174725 A1
(43) Pub. Date: Sep. 18, 2003

(54) IP multicast packet replication process and apparatus therefore

(75) Inventor: Laxman Shankar, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/247,298

(22) Filed: Sep. 20, 2002

Related U.S. Application Data
(60) Provisional application No. 60/364,049, filed on Mar. 15, 2002.

(51) Int. Cl. H04L 12/54

(52) U.S. Cl. 370/428

(57) ABSTRACT

According to one aspect of this invention, a method of controlling data flow in a network device is discussed. An incoming data packet is received and an IP multicast group number is determined from the incoming data packet. An IP multicast group vector is determined from an. IP multicast group vector table using the IP multicast group number. That IP multicast group vector is then used to obtain a series of VLAN IDs from a VLAN ID table corresponding to bit positions defined by the IP multicast group vector. The data packet is then replicated and forwarded onto each VLAN ID of the series of VLAN IDs. A network for controlling data therein is also discussed.

### REFERENCE TO RELATED APPLICATIONS

This application claims priority of United States Provisional Patent Application Serial No. 60/364,049, filed on Mar. 15, 2002. The contents of the provisional application are hereby incorporated by reference.

### BACKGROUND OF THE INVENTION

1. Field of Invention

The present invention relates to network devices, including switches, routers and bridges, which allow for data to be routed and moved in networks. More specifically, the present invention provides an optimal method of storing and processing the information required to forward multicast packets from network devices.

2. Description of Related Art

In computer networks, each element of the network performs functions that allow for the network as a whole to perform the tasks required of the network. One such type of element used in computer networks is referred to, generally, as a switch. Switches, as they relate to computer networking and to Ethernet, are hardware-based devices which control the flow of data packets or cells based upon destination address information which is available in each packet. A properly designed and implemented switch should be capable of receiving a packet and switching the packet to an appropriate output port at what is referred to wirespeed or linespeed, which is the maximum speed capability of the particular network.

Basic Ethernet wirespeed is up to 10 megabits per second, and Fast Ethernet is up to 100 megabits per second. The newest Ethernet is referred to as 10 gigabit Ethernet, and is capable of transmitting data over a network at a rate of up to 10,000 megabits per second. As speed has increased, design constraints and design requirements have become more and more complex with respect to following appropriate design and protocol rules and providing a low cost, commercially viable solution.

This is especially true as network devices become more ubiquitous and the need to create less costly and more efficient network devices has become more important. One such problem occurs when a switch receives a data packet that has to be replicated so that the packet can be forwarded to multiple destinations. When a switch receives a packet, the packet is examined to determine the packet type. The type of packet determines which tables are accessed to determine a destination port for that packet. Packets can be unicast, multicast and broadcast. A broadcast packet is sent to all output ports and a unicast packet is sent to a single destination address. Multicast packets have multiple destinations and must be replicated such that a copy of the packet can be sent to each of the multiple destinations. The existing methodologies to produce copies of the packets are redundant and expensive from the standpoint of memory and central processing unit (CPU) usage.

As such, there is a need in the prior art for an efficient method and means for forwarding multicast data between interconnected network devices. In addition, there is a need for a method that allows for efficient replication of Internet Protocol (IP) multicast packets. Such a standard would need to be compatible with the existing hardware and reduce the use of the external CPU management to maintain the necessary throughput of the network device.

### SUMMARY OF THE INVENTION

It is an object of this invention to overcome the drawbacks of the above-described conventional network devices and methods. The present invention provides for a new method and apparatus for storing and processing the information required to forward IP multicast packets from network devices.

According to one aspect of this invention, a method of controlling data flow in a network device is discussed. An incoming data packet is received and an IP multicast group number is determined from the incoming data packet. An IP multicast group vector is determined from an. IP multicast group vector table using the IP multicast group number. That IP multicast group vector is then used to obtain a series of VLAN IDs from a VLAN ID table corresponding to bit positions defined by the IP multicast group vector. The data packet is then replicated and forwarded onto each VLAN ID of the series of VLAN IDs.

Alternatively, the method can include determining an incoming VLAN ID for the data packet and then determining whether the incoming VLAN ID is the same as one VLAN ID of the series of VLAN IDs. When the incoming VLAN ID is the same as one VLAN ID, the data packet is forwarded for the one VLAN ID based on Level 2 values of the data packet. Also, an IP time to live value can be decremented and an IP checksum may be recalculated when a copy of the data packet is forwarded onto each VLAN ID. In addition, the source address value in the data packet may be replaced with an IP multicast router MAC address when a copy of the data packet is forwarded onto each VLAN ID. Also, when the egress port is a tagged port, the data packet may be tagged with the VLAN ID.

According to another aspect of this invention, a network device for controlling data flow in the device is disclosed. The device may include receiving means for receiving an incoming data packet and a determining means for determining an IP multicast group number from the incoming data packet. The device also includes obtaining means for obtaining an IP multicast group vector from an. IP multicast group vector table using the IP multicast group number, obtaining means for obtaining a series of VLAN IDs from a VLAN ID table corresponding to bit positions defined by the IP multicast group vector and replicating and forwarding means for replicating and forwarding the data packet onto each VLAN ID of the series of VLAN IDs.

According to another aspect of this invention, a network device for controlling data flow in the device is also disclosed. The device includes a buffer configured to receive an incoming data packet and a buffer access device configured to determine an IP multicast group number from the incoming data packet. The device includes a table access device configured to obtain an IP multicast group vector from an. IP multicast group vector table using the IP multicast group number and a table access device configured to obtain a series of VLAN IDs from a VLAN ID table corresponding to bit positions defined by the IP multicast group vector. The device also includes a replicator configured to replicate the data packet based on the series of VLAN IDs and a forwarding device configured to forward the data packet onto each VLAN ID of the series of VLAN IDs.

These and other objects of the present invention will be described in or be apparent from the following description of the preferred embodiments.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 is a general block diagram of a network device and associated modules for use with the present invention;

FIG. 2 is a general block diagram illustrating the forwarding of a multicast packet from a switch; and

FIG. 3 is a flowchart illustrating the processes performed, according to one embodiment of the present invention.

### DETAILED DESCRIPTION OF PREFERRED EMBODIMENTS

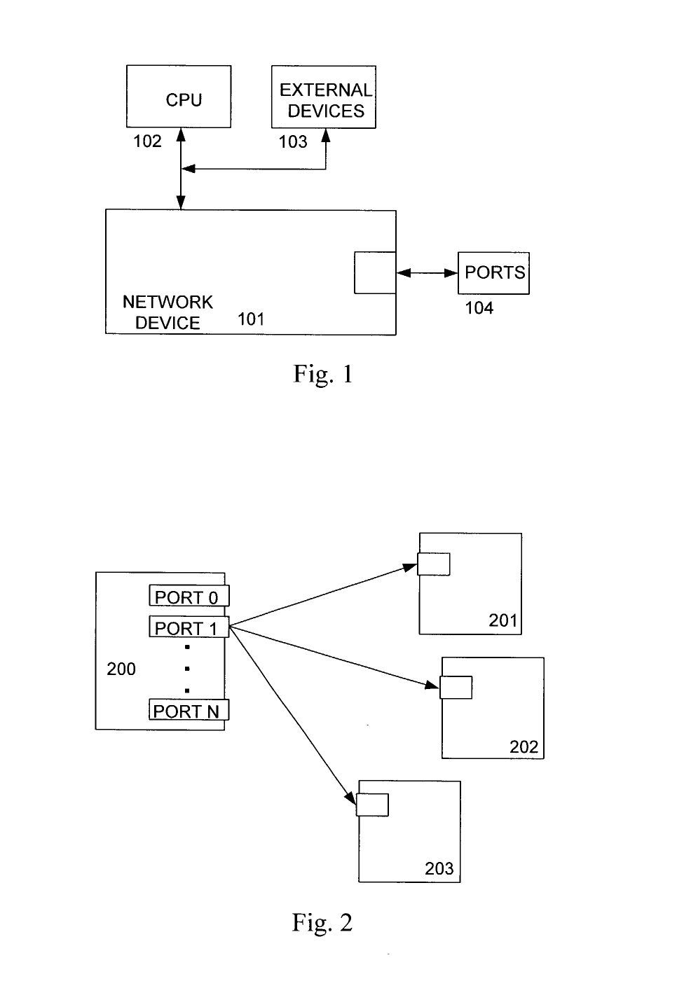

FIG. 1 illustrates a configuration of a node of the network, in accordance with the present invention, is illustrated. The network device 101 is connected to a Central Processing Unit (CPU) 102 and other external devices 103. The CPU can be used as necessary to program the network device 101 with rules that are appropriate to control packet processing. Ideally, the network device 101 should be able to process data received through physical ports 104 with only minimal interaction with the CPU and operate, as much as possible, in a free running manner.

FIG. 2 illustrates the logical process of forwarding a multicast packet. The initial network device 200 receives a multicast packet and processes that packet. Such processing can include classifying the packet, modifying the packet and changing the packet forwarding behavior. The processing can also include mirroring the packet to some other port, sending the packet to a certain class of service priority queue or changing the type of service. Egress port 1, in the illustrated example, replicates the packet so that it can forward the packet to each of the destination network devices 201, 202 and 203. The network devices that receive a copy of the packet are determined by data contained in the packet, as described below.

IP multicast replication requires packets from a source port in a network device to be replicated and forwarded on to ports of the device on which members of the IP multicast group exist. For large amounts of data, IP Multicast is more efficient than normal Internet transmissions because the server can forward a message to many recipients simultaneously. Unlike traditional Internet traffic that requires separate connections for each source-destination pair, IP Multicasting allows many recipients to share the same source. This means that just one set of packets is transmitted for all the destinations. The IP multicast group is the set of ports listed as belonging to a particular IP multicast group number.

The packets may be switched, bridged or routed based on the destination IP address. In particular, when multiple destinations for the packet reside on the same output port, the packet will need to be replicated on the same port as many times as the number of broadcast domains Virtual Local Area Networks (VLANs) present on the output port. A VLAN is a network of computers that behave as if they are connected to the same wire even though they may actually be physically located on different segments of a local area network. VLANs are usually configured through software rather than hardware, which makes them extremely flexible. One of the biggest advantages of VLANs is that when a computer is physically moved to another location, it can stay on the same VLAN without any hardware reconfiguration.

An existing implementation for replication of IP multicast packets over 32 VLANs, for example, stores the following information at each egress port:

TABLE 1

| Index = IP | | VLAN | VLAN | | |
|---|---|---|---|---|---|
| Multicast Group | Count | ID #1 | ID #2 | | VLAN ID #32 |
| number | (5 bits) | (12 bits) | (12 bits) | . . . | (12 bits) |
| 0 | 2 | 1 | 15 | | 300 |
| 1 | 15 | 2 | 1 | | 45 |
| 2 | 32 | 23 | 4 | | 44 |
| . . . | | | | | |

In Table 1 the entries are indexed by the IP multicast group number. Each entry contains a list of the VLAN IDs that are 12 bit quantities. The VLAN IDs are inserted into the VLAN tag of the tagged Ethernet frames that are sent out over the egress port on the VLANs represented by each VLAN ID. The IEEE 802.1q specification for “tagging” frames defines a method for coordinating VLANs across multiple switches. In the specification, an additional “tag” header is inserted in a frame after the source MAC address and before the frame type. By coordinating VLAN IDs across multiple switches, VLANs can be extended to multiple switches. Additionally, the Count field of Table 1 indicates how many entries in the VLAN ID list are valid.

When an IP multicast packet is to be sent out on an egress Ethernet port, the IP multicast replication table is indexed by the IP multicast group number and the packet is replicated and forwarded on each VLAN in the VLAN ID list, up to Count number of VLANs. If the number of IP multicast groups supported is 512 and the number of VLANs per port is 32, the memory size required in each egress port equals 199168 bits.

The existing implementation stores the information required for IP multicast in a redundant and expensive way. Also, keeping the VLAN IDs sorted in the table adds significant overhead to the management CPU.

According to the present invention, an optimal method of storing and processing the information required to replicate IP multicast packets is described. Compared to the existing method, described above, this proposal reduces the memory required by a factor of ten.

According to one embodiment of the present invention, two tables are stored in each egress Ethernet port, examples of which are:

TABLE 2

| Index = | |
|---|---|
| IPMG # | Bit Vector |
| 0 | 1 0 1 0 0 0 0 0 0 0 0 0 0 0 0 0 0 0 0 0 0 0 0 0 0 0 0 0 1 0 1 0 |
| 1 | 0 0 0 0 0 0 0 0 0 0 0 0 0 0 0 1 1 1 0 0 0 0 0 0 0 0 0 0 0 1 1 0 |
| 2 | 1 1 1 1 1 1 1 1 1 1 1 1 1 1 1 1 1 1 1 1 1 1 1 1 1 1 1 1 1 1 1 1 |
| . . . | |

TABLE 3

| Index = IPMG # | VLAN ID (12 bits) |
|---|---|
| 0 | 300 |
| 1 | 44 |
| 2 | 21 |
| . . . | |

An IP multicast packet arriving at the egress port is forwarded according to the following steps. First, the IP multicast group number is used to index into the IP multicast group vector table. Each pit position in this table is the index into the IP multicast VLAN ID table. The VLAN ID table stores the VLAN IDs corresponding to each bit position in the IP multicast group vector table entry. Next, the packet is replicated and forwarded onto each VLAN ID in the IP multicast VLAN ID table, for which a bit is set to “1” in the IP multicast group vector table. If the incoming VLAN ID of the packet is the same as the VLAN ID from the VLAN ID table, the packet is L2 forwarded, i.e. forwarded according to Layer 2 values of the packet.

If the incoming VLAN ID of the packet is different, the packet is routed on to the outgoing VLAN. The IP TTL is decremented and the IP checksum is recalculated. The Source Address (SA) of the packet is replaced with the IP multicast router Media Access Controller (MAC) address). If the egress port is a tagged port, the packet is tagged with the appropriate VLAN ID. Else the packet is forwarded as an untagged packet.

For a 512 group IP multicast implementation, assuming a requirement to replicate over 32 VLANs on an egress port, the memory requirement using this method is 16768 bits. This is less by a factor greater than ten compared to the existing implementation.

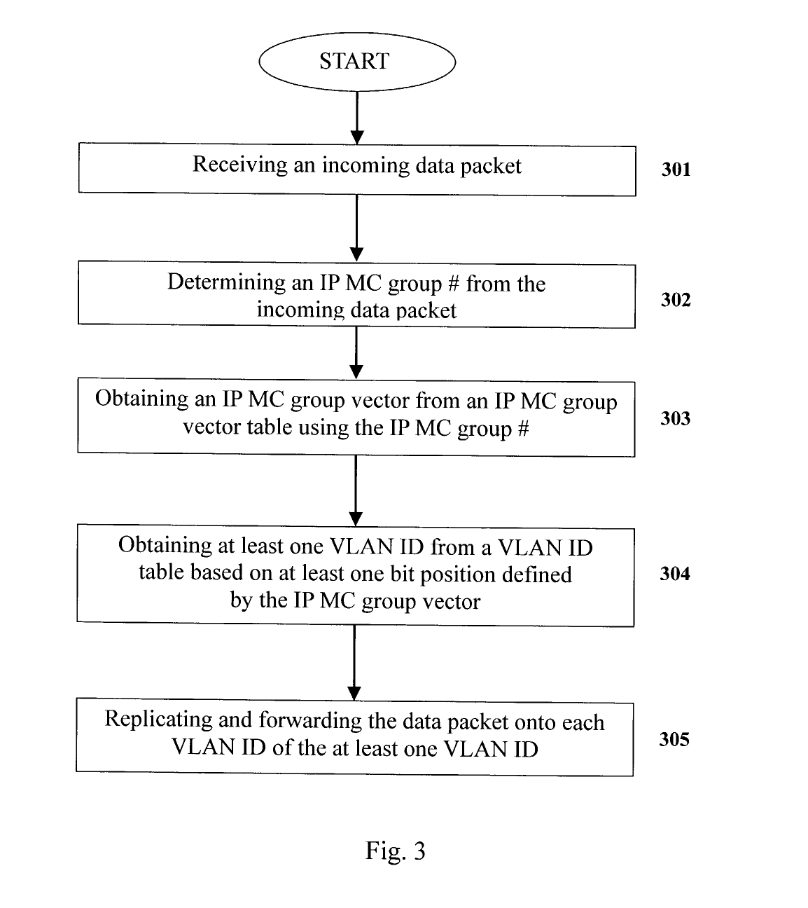

The general process of IP multicasting, according to one embodiment of the present invention, is illustrated in FIG. 3. In step 301, an incoming data packet is received and an IP multicast group number is determined from the incoming data packet, in step 302. An IP multicast group vector is obtained from an IP multicast group vector table using the IP multicast group number, in step 303. At least one VLAN ID is obtained from a VLAN ID table based on at least one bit position defined by the IP multicast group vector, in step 304. In step 305, the data packet is replicated and forwarded onto each VLAN ID of the at least one VLAN ID.

Thus, the optimal IP multicast replication mechanism that has been described, according to one embodiment of the present invention, reduces the memory requirement compared to existing methods by a factor of ten and allows ease of configuration by a management CPU.

In addition, while the term packet has been used in the description of the present invention, the invention has import to many types of network data. For purposes of this invention, the term packet includes packet, cell, frame, datagram, bridge protocol data unit packet, and packet data.

The above-discussed configuration of the invention is, in one embodiment, embodied on a semiconductor substrate, such as silicon, with appropriate semiconductor manufacturing techniques and based upon a circuit layout which would, based upon the embodiments discussed above, be apparent to those skilled in the art. A person of skill in the art with respect to semiconductor design and manufacturing would be able to implement the various modules, interfaces, and components, etc. of the present invention onto a single semiconductor substrate, based upon the architectural description discussed above. It would also be within the scope of the invention to implement the disclosed elements of the invention in discrete electronic components, thereby taking advantage of the functional aspects of the invention without maximizing the advantages through the use of a single semiconductor substrate.

Although the invention has been described based upon these preferred embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

What is claimed is:

1. A method of controlling data flow in a network device, said method comprising:
receiving an incoming data packet;
determining an IP multicast group number from said incoming data packet;
obtaining an IP multicast group vector from an IP multicast group vector table using said IP multicast group number;
obtaining at least one virtual local area network identifier from a virtual local area network identifier table corresponding to at least one bit position defined by the IP multicast group vector; and
replicating and forwarding said data packet onto each virtual local area network identifier of said at least one virtual local area network identifier.

2. A method as recited in claim 1, further comprising:
determining an incoming virtual local area network identifier for said data packet;
determining whether said incoming virtual local area network identifier is the same as one virtual local area network identifier of said at least one virtual local area network identifier; and
forwarding the data packet for said one virtual local area network identifier based on Level 2 values of said data packet when said incoming virtual local area network identifiers is the same as one virtual local area network identifier.

3. A method as recited in claim 1, further comprising:
decrementing an IP time to live value and recalculating an IP checksum when a copy of the data packet is forwarded onto each virtual local area network identifier.

4. A method as recited in claim 1, further comprising:
replacing a source address value in said data packet with an IP multicast router MAC address when a copy of the data packet is forwarded onto each virtual local area network identifier.

5. A method as recited in claim 1, further comprising:
tagging said data packet with said each virtual local area network identifier when an egress port through which the replicated data packet is forwarded is a tagged port.

6. A network device for controlling data flow in said device comprising:
receiving means for receiving an incoming data packet;
determining means for determining an IP multicast group number from said incoming data packet;
obtaining means for obtaining an IP multicast group vector from an. IP multicast group vector table using said IP multicast group number;
obtaining means for obtaining a at least one virtual local area network identifier from a virtual local area network identifier table corresponding to bit positions defined by the IP multicast group vector; and
replicating and forwarding means for replicating and forwarding said data packet onto each virtual local area network identifier of said at least one virtual local area network identifier.

7. A network device as recited in claim 6, further comprising:
determining means for determining an incoming virtual local area network identifier for said data packet;
determining means for determining whether said incoming virtual local area network identifier is the same as one virtual local area network identifier of said at least one virtual local area network identifier; and
forwarding means for forwarding the data packet for said one virtual local area network identifier based on Level 2 values of said data packet when said incoming virtual local area network identifier is the same as one virtual local area network identifier.

8. A network device as recited in claim 6, further comprising:
decrementing means for decrementing an IP time to live value; and
recalculating means for recalculating an IP checksum when a copy of the data packet is forwarded onto each virtual local area network identifier.

9. A network device as recited in claim 6, further comprising:
replacing means for replacing a source address value in said data packet with an IP multicast router MAC address when a copy of the data packet is forwarded onto each virtual local area network identifier.

10. A network device as recited in claim 6, further comprising:
tagging means for tagging said data packet with said each virtual local area network identifier when an egress port through which the replicated data packet is forwarded is a tagged port.

11. A network device for controlling data flow in said device comprising:
a buffer configured to receive an incoming data packet;
a buffer access device configured to determine an IP multicast group number from said incoming data packet;
a table access device configured to obtain an IP multicast group vector from an. IP multicast group vector table using said IP multicast group number;
a table access device configured to obtain a at least one virtual local area network identifier from a virtual local area network identifier table corresponding to bit positions defined by the IP multicast group vector; and
a replicator configured to replicate said data packet based on said at least one virtual local area network identifier; and
a forwarding device configured to forward said data packet onto each virtual local area network identifier of said at least one virtual local area network identifier.

12. A network device as recited in claim 11, further comprising:
a buffer access device configured to determine an incoming virtual local area network identifier for said data packet;
a comparator configured to determine whether said incoming virtual local area network identifier is the same as one virtual local area network identifier of said at least one virtual local area network identifier; and
a forwarding device configured to forward the data packet for said one virtual local area network identifier based on Level 2 values of said data packet when said incoming virtual local area network identifier is the same as one virtual local area network identifier.

13. A network device as recited in claim 11, further comprising:
a counter configured to decrement an IP time to live value; and
a calculator configured to recalculate an IP checksum when a copy of the data packet is forwarded onto each virtual local area network identifier.

14. A network device as recited in claim 11, further comprising:
a buffer access device configured to replace a source address value in said data packet with an IP multicast router MAC address when a copy of the data packet is forwarded onto each virtual local area network identifier.

15. A network device as recited in claim 11, further comprising:
a buffer access device configured to tag said data packet with said each virtual local area network identifier when an egress port through which the replicated data packet is forwarded is a tagged port.

16. A network device as recited in claim 11, wherein said network device comprises a network switch.

17. A network device as recited in claim 11, wherein said network device comprises a network router.

18. A network device as recited in claim 11, wherein said network device comprises a network repeater.
